(19) United States
(12) Patent Application Publication
(10) Pub. No.: US 2017/0197102 A1
(43) Pub. Date: Jul. 13, 2017

(54) MANUAL ACTUATOR FOR FIRE SUPPRESSION SYSTEMS

(71) Applicant: TYCO FIRE PRODUCTS LP, Lansdale, PA (US)

(72) Inventors: Derek M. SANDAHL, Wallace, MI (US); Marvin B. FERNSTRUM, Menominee, MI (US); Brian L. COUNTS, Menominee, MI (US)

(21) Appl. No.: 15/370,799

(22) Filed: Dec. 6, 2016

Related U.S. Application Data
(63) Continuation of application No. PCT/US2015/033141, filed on May 29, 2015.
(60) Provisional application No. 62/008,984, filed on Jun. 6, 2014.

(51) Int. Cl. A62C 37/36; A62C 35/02; A62C 37/50

(52) U.S. Cl. CPC A62C 37/36; A62C 37/50; A62C 35/02; A62C 3/07

(57) ABSTRACT

Fire protection systems and methods for the protection of multiple areas of an occupancy. The system includes detectors for detecting a fire condition in an area of the occupancy and release assemblies for discharging a firefighting agent into a hazard area of the occupancy. The system includes a plurality of manual actuating devices to manually actuate the release assemblies. Each of the manual actuating devices includes an indicator for visually and/or audibly identifying the manual actuating device for operation in response to a fire condition.

### PRIORITY DATA & INCORPORATION BY REFERENCE

This application is an international application claiming the benefit of priority to U.S. Provisional Application No. 62/008,984, filed Jun. 6, 2014, which application is incorporated by, reference in its entirety.

### FIELD OF INVENTION

The present invention is directed to fire suppression systems for vehicles and industrial applications. More specifically, the present invention is directed to manual actuators for use in fire suppression systems for vehicles and industrial applications.

### BACKGROUND OF THE INVENTION

Known firefighting systems for vehicles and industrial applications include a firefighting agent supply coupled to one or more fixed nozzles to protect multiple hazards or hazard areas. Generally, the systems include multiple detectors designated for monitoring and detection of an area or occupancy, a storage or supply of a firefighting agent, firefighting devices for distributing the agent and a control system to control delivery of the agent to the distribution devices. The systems can include manual actuators for use in the release of the firefighting agent. Known manual actuators can he electric or mechanical functioning devices that are coupled to the firefighting hardware or devices of the system. Exemplary systems that provide for manual actuation include restaurant tire suppression systems, vehicle fire suppression systems, or clean agent systems, such as for example, INERGEN® fire extinguishment from Tyco Fire & Intergated Solutions (UK) Ltd of Tyco International Ltd., Halocarbon, or carbon dioxide (CO2) fixed systems.

In some installations, such as in off-road heavy vehicles, the manual actuators for multiple zones are often installed in a central location. The central location may have multiple actuators lined up next to each other, for example, in a bank of manual actuators. The central location could be an egress path for the vehicle operator. Known manual actuators do not provide or include identification means for identifying which manual actuator is to be operated to actuate the appropriate devices to address the appropriate area for release of firefighting agent in response to a fire condition. Prior solutions to the problem use separate actuating devices and notification devices. This requires more components, more installation time and increased product cost. Accordingly, there is need for manual actuators that integrate manual operation with an identifying function to facilitate the appropriate selection and operation of the manual actuators.

### DISCLOSURE OF THE INVENTION

The present invention is directed to systems and methods for use in fire protection systems for vehicles or industrial applications. Preferred embodiments include a manual actuating device that includes an operating mechanism for manual release of a firefighting agent, an indicator for selectively identifying the actuating device for manual operation; and a housing for housing each of the operating mechanism and the indicator. A preferred embodiment of a fire protection system includes a release device for releasing a firefighting agent into one of a plurality of hazard areas; and a manual actuating device including an indicator to identify the manual actuating device for operating the release device. The preferred indicator has a first condition in which the indicator is in a standby state and a second condition in which the indicator is in an identify state to identify the manual actuating device for operation.

Another preferred re protection system includes a plurality of detectors with each of the plurality of detectors configured to generate a detection signal upon detecting a fire condition in one of a plurality of hazard areas. A plurality of release assemblies is provided in which each of the plurality of release assemblies is configured to discharge a fire fighting agent into one of the plurality of hazard areas. A plurality of manual actuating devices are each configured to manually actuate at least one release assembly that is different than at least one release assembly actuated by another manual actuating device. Each of the manual actuating devices preferably includes a housing having an indicator with a standby state and an identify state to identify the manual actuating device for operation. The system preferably includes a controller in communication with each of the manual actuating devices to selectively operate at least one indicator from the standby state to the identify state to identify the at least one manual actuating device for actuating the at least one release assembly for discharge of the firefighting agent into the at least one of a plurality of hazard areas for which a fire condition has been detected by at least one detector. A preferred method of fire protection is provided that includes detecting a fire condition in at least one of the hazard areas; and selectively identifying a manual actuator at the actuator for manual operation to release a firefighting agent into the at least one hazard area.

Although the Disclosure of the Invention and the preferred systems and methods address the disadvantages of known fire suppression systems for vehicles and industrial applications it is to be understood that any fire protection system capable of incorporating the preferred systems and methods described herein can be covered. The Summary of the Invention is provided as a general introduction to some embodiments of the invention, and is not intended to he limiting to any particular configuration or system. It is to he understood that various features and configurations of features described in the Summary of the Invention can be combined in any suitable way to form any number of embodiments of the invention. Some additional example embodiments including variations and alternative configurations are provided herein.

### BRIEF DESCRIPTIONS OF THE DRAWINGS

The accompanying drawings, which are incorporated herein and constitute part of this specification, illustrate exemplary embodiments of the invention and, together with the general description given above and the detailed description given below, serve to explain the features of the exemplary embodiments of the invention.

FIG. 1 is schematic illustration of one preferred embodiment of a fire protection system.

FIG. 2 is a schematic illustration of another embodiment of a fire protection system.

FIG. 3 is a schematic illustration of an exemplary arrangement for use in the systems of FIGS. 1-2.

### DETAILED DESCRIPTION OF THE PREFERRED EMBODIMENTS

Preferred embodiments of fire protection systems and methods for the protection of multiple areas of an occupancy, location or site are provided. Generally, the system 10 includes detection means 12 for detecting a fire condition in an area of the occupancy and a release means 14 for discharging a firefighting agent into a hazard area of the occupancy. The system 10 includes a plurality of manual actuators or manual actuating devices 16 to manually actuate the release means 14. Each of the preferred embodiments of the manual actuating devices 16 includes an indicator 18 for visually and/or audibly identifying the manual actuating device 16 for operation. In the preferred operation of the system 10, a fire condition is detected in one or more of the hazard areas and the indicators 18 are selectively operated to identify the appropriate manual actuating device(s) 16 for manual operation to discharge a firefighting agent into the hazard area(s) in which a fire condition was detected. It should be understood that the preferred manual actuating devices 16 can be implemented in systems that include and provide for automated actuation and release of the firefighting agent. Accordingly, the identifying manual actuating devices 16 can be implemented in known fire protection systems, for example those previously described, that provide for automatic and manual actuation.

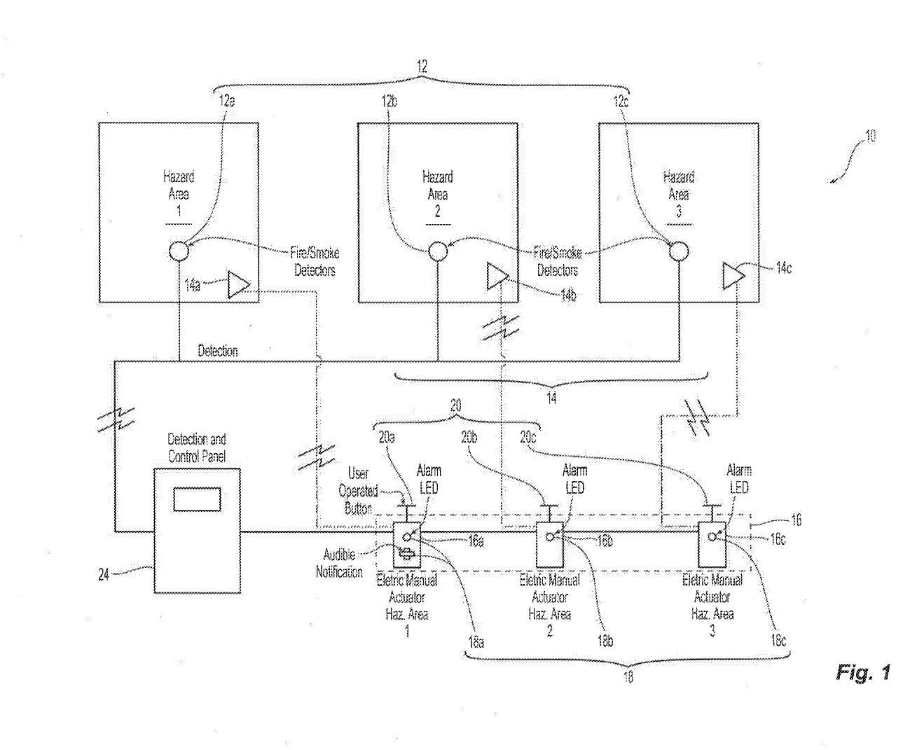

With reference to FIG. 1, the actuating device 16 preferably includes a manually operable mechanism 20 such as for example, a toggle switch, a push-button, or a lever, which upon manual operation preferably generates an actuating signal that actuates the release means 14 for discharge of the firefighting agent in a manner described herein or otherwise known. The indicator 18 is preferably embodied as any one of a visual alarm and/or an audible alarm. The indicator 18 can he embodied as a visual alarm, such as for example, a light-emitting diode (LED) indicator, text sign, color or flashing indicator or other visual indicator to identify the actuating device 16 for operation. Alternatively or in addition, the indicator 18 can be embodied as an audible indicator, such as for example, a buzzer, ringer, voice or other distinct sound, to identify the actuator 16 for operation. Further in the alternative or additionally, the indicator 18 can provide other information, such as for example, the particular area to be addressed by the actuating device or information regarding the detected fire condition.

Regardless of the type of indicator, the indicator 18 defines a first standby state and a second identify state. Upon receipt of an appropriate signal, the indicator 18 alters state going from the standby state to the identify state in which the indicator 18 is energized or operated to identify the manual actuating device 16 for operation. In order that an indicator 18 properly identifies the manual actuating device 16 for operation, the indicator 18 is properly associated with a manual actuating device 16 to be identified by the indicator. In a preferred embodiment, the manual actuating device 16 and indicator 18 are preferably integrated into a single housing or unit 22 to associate the indicator 18 with a particular manual actuating device 16 and operable mechanism 20 for proper identification upon energizing the indicator 18. Accordingly, in one preferred aspect the identification of the manual actuating device 16 for operation is identified at the device itself. Moreover, integrating the manual actuating device 16, operable mechanism 20 and indicator 18 in the preferred housing 22 facilitates their installation and coupling, as a single unit, to the system 10 or another device in the system 10 thereby eliminating the need for separate installations and/or hardware for each of the actuating device 16 and the indicator 18. Preferred embodiments of the housing 22 include a single connector for coupling to the system 10 such that all input and output signals in and out of the housing 22 pass through or are carried by the single connector. Accordingly to the extent the manual actuating device 16 is hard wired to the system 10, the preferred embodiments of the housing 22 eliminate or minimize the amount of conduit needed to connect the manual actuating device 16 and its associated indicator 18.

FIG. 1 schematically shows a preferred illustrative embodiment of the system 10 for the protection of an occupancy. The areas to be protected by the system 10 are shown schematically as discrete hazard areas 1, 2, 3. It should be understood that the systems and methods described herein are applicable to locations with two protection areas or locations having more than three areas. The hazard areas can be individually enclosed areas isolated from one another; or alternatively, the hazard areas can be identifiable zones of a larger area which are in communication with one another. The preferred system 10 can be used in different types of applications, for example, a storage occupancy, a vehicle such as, for example, a ship, cargo planes, or off-road heavy equipment, each of which has several areas in need of fire protection.

The preferred detection means 12 of the system 10 includes a plurality of detectors 12a, l 2b, 12e for monitoring and detecting a fire condition in the protection area, each detector preferably configured to generate a detection signal upon detecting a fire condition in the protection area. The detection signal is preferably in a form that can be communicated to another device as an input signal to that device. The detection signal is preferably an electronic signal, digital or analog, for being conveyed or communicated over wire, fiber optic, cable or other appropriate medium. Alternatively, the detection signal can be a wireless signal, such as for example, Bluetooth signal, other radio signal or other type of wave signal. Embodiments of the detectors 12 can further provide for visual and/or audio alarm in response to detecting a fire condition. Known detector devices for use in the system can include analog and digital devices for various modes for fire detection including: (i) spot thermal detectors to determine when the surrounding air exceeds a set temperature, (ii) linear detection wire which conveys a detection signal from two wires that are brought into contact upon a separating insulation material melting in the presence of a fire, (iii) optical sensors which differentiate between open flames and hydrocarbon signatures, and (iv) a linear pressure detector in which pressure of an air line increases in the presence of sufficient heat.

A preferred release means 14 is respectively installed or positioned for discharge of a firefighting agent into a hazard area in response to a fire condition. A preferred release means 14 is embodied as a releasing assembly that includes a source or supply of firefighting agent, a device for controlling release of the agent from the supply and a distributor for discharging and/or distributing the agent within the hazard area. In the preferred system 10, release means 14a, 14b, 14c are respectively installed or positioned within each of the hazard areas 1, 2, 3 for discharge of the firefighting agent into the hazard area in response to a fire condition. Associated or coupled directly or indirectly to each of the release means or assemblies 14a, 14b, 14c, respectively, are preferred manual actuating devices 16a, 16b, 16c. The release means and manual actuating devices are preferably associated with one another at a one-to-one ratio (1:1). Alternatively, the components may be associated at a release means to-manual actuating device ratio of greater than 1:1 provided that manual actuating device 16a actuates one or more release means or assemblies 14 that is different than the release means or assemblies 14 actuated by the other manual actuating devices 16b, 16c. In the preferred system 10, the manual actuating devices 16a, 16b, 16c are preferably located remotely from their respectively associated release assemblies 14a, 14b, 14c. Moreover, the manual actuating devices 16a, 16b, 16c are preferably located remotely and centralized, for example, in an area of egress, for access by personnel in the area of the occupancy.

Following detection of a fire condition in any one of the hazard areas 1, 2, 3 by the detectors 12a, 12b, 12c, the indicators 18a, 18b, 18c of the manual actuating devices 16a, 16b, 16c are selectively operated to identify an appropriate manual actuating device for manual operation. Upon operation, each identified manual actuating device(s) 16a, 16b, 16c provides an appropriate actuating signal to the release means 14a, 14b, 14c associated with the operated manual actuating Appropriate actuating signals can include electrical signals, pneumatic signals or any other type of signal to actuate the control device of the preferred release means. The electrical signals can be communicated over wires or cables or alternatively communicated wirelessly. In response, the release means 14a, 14b, 14c discharges and preferably distributes the firefighting agent into the hazard areas 1, 2, 3.

In the preferred system 10 of FIG. 1, the detection means 12, release means 14 and manual actuating devices 16 are coupled or interconnected by control means and more preferably a centralized controller 24 to provide preferred automated and manual operation and monitoring of the system 10. In the preferred system 10, the controller 24 is preferably in communication with each of the plurality of detectors 12a, 12b, 12c to receive the generated detection signals from each of the plurality of detectors. The preferred controller 24 is also preferably in communication and more preferably in two-way communication with each of the manual actuating devices 16a, 16b, 16c to selectively operate an indicator 18 from its first standby state to its second identify state in response to a venerated detection signal in order to identify one or more appropriate manual actuating devices 16 for manual operation to manually actuate release means 14 in a manner as described herein. Accordingly, each of the plurality of manual actuating devices 16 is preferably individually addressable by the controller 24. As previously described, upon operation, each identified manual actuating device(s) 16a, 16b, 16c can provides an appropriate actuating signal to the release means 14a, 14b, 14c associated with the operated manual actuating device. Alternatively or in addition, each of the manual actuating devices 16a, 16b, 16c can actuate the associated release means or assembly 14a, 14b, 14c with an electrical actuating signal via the controller 24. The communication between the controller 24 and the detectors 12, release means 14 and manual actuating devices 16 can be configured for wire communication, such as for example, analog or digital communication. In order to facilitate the preferred two-way digital communication between the controller 24 and the manual actuating devices 16, each of the controller 24 and the manual actuating devices 16 preferably includes an appropriate processor for receipt, processing and output of the communication signals. Alternatively or additionally, the communication can be configured for wireless communication including, for example, Bluetooth or other radio communication.

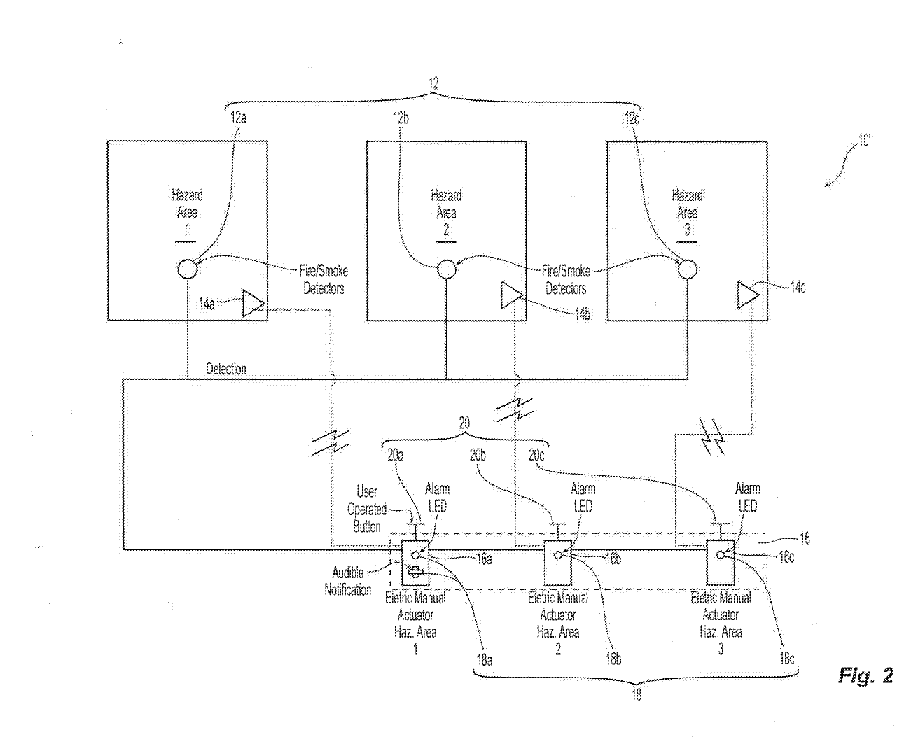

Shown in FIG. 2 is an alternate embodiment of the system 10′ without the centralized controller. In the alternate system, the detectors 12a, 12b, 12c are respectively directly coupled with the manual actuating devices 16a, 16b, 16c in order to provide a generated detection signal for operating the indicators 18a, 18b, 18c of the associated manual actuating devices 16a, 16b, 16c. Accordingly, in the alternate system 10′ the manual actuating devices 16a, 16b, 16c are selectively identified for manual actuation directly by the generated detection signals.

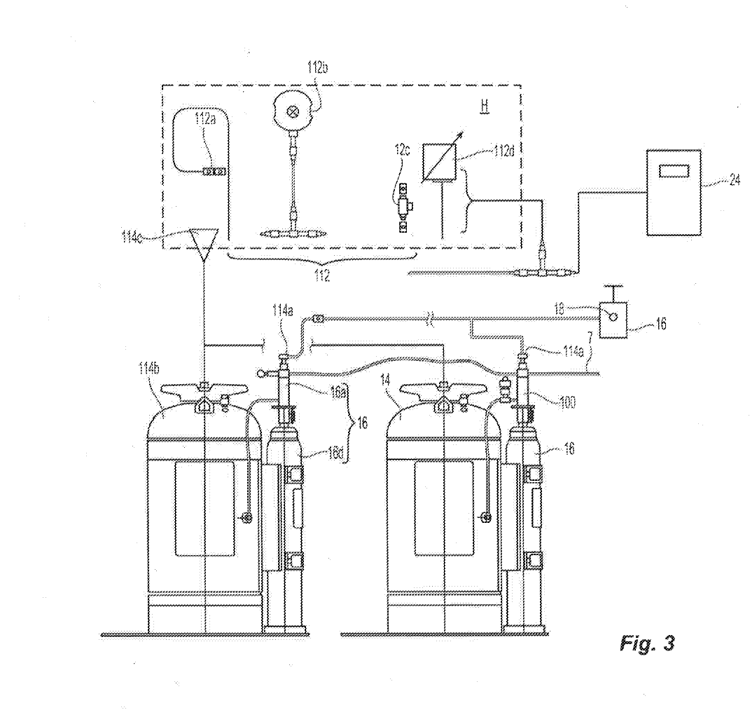

Shown in FIG. 3 is an exemplary preferred arrangement to provide for the manual operation previously described. The arrangement includes a preferred manual actuating device 16 and exemplary release assembly 114 with multiple detectors 112a, 112b, 112c, 112d to detect a fire condition in a hazard area H. A preferred release assembly 114 includes a release device 114a coupled to a firefighting agent supply 114b for controlled release and a distributor or distribution device 114c for distributing the agent in the hazard area H. Distribution devices 114c for use in the system 10 can include nozzles, mist nozzles, diffusers or automatic fire sprinklers. The firefighting agent supply 114b can include one or more storage tanks or cylinders containing the firefighting agent, such as for example a chemical agent, such as for example, INERGEN® fire extinguishment from Tyco Fire & Intergated Solutions (UK) Ltd of Tyco International Ltd., or Halocarbon or Carbon Dioxide (CO₂) agents. Each storage tank 114b can include a sealed cylinder or cartridge containing a pressurized gas, such as for example nitrogen, for pressurizing the supply tank(s) in order to deliver the agent under an operating pressure to a fluid distribution device 114c to address a fire condition in the hazard area H. The release device 114a can control discharge of the firefighting agent by controlling the release of pressurized gas to the agent supply. The release device 114a can be embodied as an electrically or pneumatically operated puncturing assembly that ruptures a sealing disc to release the pressurizing gas for pressurizing the firefighting agent for delivery to the fluid distribution device 114c. The preferred manual actuating device 16 is appropriately configured to provide, upon manual operation, the appropriate actuating signal to the release device 114a. Accordingly, the manual actuating device 16 can actuate the release assembly 114a associated with the manual actuating device with an electrical or a pneumatic actuating signal, alone or via the controller 24.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

1. A fire protection system for protecting an occupancy defining a plurality of hazard areas, the system comprising:
a plurality of detectors, each of the plurality of detectors being configured to generate a detection signal upon detecting a fire condition in one of the plurality of hazard areas;
a plurality of release assemblies, each of the plurality of release assemblies being configured to discharge a firefighting agent into one of the plurality of hazard areas;
a plurality of manual actuating devices, each of the manual actuating devices being configured to manually actuate at least one release assembly that is different than at least one release assembly actuated by another manual actuating device, each of the manual actuating devices including a housing having an indicator with a standby state and an identify state to identify the manual actuating device for operation; and
a controller in communication with each of the manual actuating devices to selectively operate at least one indicator from the standby state to the identify state to identify at least one manual actuating device for actuating the at least one release assembly for discharge of the firefighting agent into the at least one of the plurality of hazard areas for which a fire condition has been detected by at least one detector.

2. The system of claim 1, wherein the controller is in communication with each of the plurality of detectors to receive the generated detection signals from each of the plurality of detectors.

3. The system of claim 1, wherein the indicator includes at least one of a visual alarm and an audible alarm.

4. The system of claim 3, wherein the indicator consists of a visual alarm.

5. The system of claim 4, wherein the visual alarm is an LED indicator.

6. The system of claim 3, wherein the indicator consists of an audible alarm.

7. The system of claim 1, wherein each of the plurality of manual actuating devices is individually addressable by the controller.

8. The system of claim 1, wherein the controller operates the indicators in each of the manual actuating devices via digital communication, wireless communication, Bluetooth, or analog communication.

9. The system of claim 1, wherein each of the manual actuating devices actuates the release assembly associated with the manual actuating device with an electrical actuating signal via the controller.

10. The system of claim 9, wherein each housing includes a single connector for carrying the electrical actuating signal to the controller and a selective operating signal from the controller to operate the indicator.

11. The system of claim 1, wherein each of the manual actuating devices actuates the release assembly associated with the manual actuating device with a pneumatic actuating signal via the controller.

12. A method of fire protection of a plurality of hazard areas of an occupancy, the method comprising:
detecting a fire condition in at least one of the hazard areas; and
selectively identifying a manual actuator at the actuator for manual operation to release a firefighting agent into the at least one hazard area.

13. The method of claim 12, wherein selectively identifying includes operating at least one of a visual indicator and an audible indicator to identify the manual actuator for actuation.

14. The method of claim 13, wherein detecting includes generating a detection signal, and operating includes the detection signal operating the at least one of a visual indicator and audio indicator in response to the detection signal.

15. The method of claim 13, wherein detecting includes generating a detection signal, and the operating includes a controller signaling operation of the at least one of a visual indicator and audio indicator in response to the detection signal.

16. The method of claim 13, wherein operating includes operating the at least one of the visual indicator and the audio indicator disposed in a housing, the manual actuator being disposed in the housing.

17. A fire protection system for protecting an occupancy defining a plurality of hazard areas, the system comprising:
a release device for releasing a firefighting agent into one of the plurality of hazard areas; and
a manual actuating device including an indicator to identify the manual actuating device for operating the release device, the indicator having a first condition in which the indicator is in a standby state and a second condition in which the indicator is in an identify state to identify the manual actuating device.

18. The system of claim 17, wherein the indicator includes at least one of a visual alarm and an audible alarm.

19. The system of claim 18, wherein the indicator consists of a visual alarm.

20. The system of claim 19, wherein the visual alarm is an LED indicator.

21. The system of claim 18, wherein the indicator consists of an audible alarm.

22. The system of claim 17, further comprising a fire detector for operating the indicator from the standby state to the identify state.

23. The system of claim 17, further comprising a detector for operating the indicator from the standby state to the identify state.

24. The system of claim 23, further comprising a controller in two-way communication with the detector and the indicator.

25. The system of claim 17, wherein the manual actuating device includes a housing, the indicator and a manual operable mechanism being disposed in the housing.

26. An actuating device comprising:
an operating mechanism for actuating a release device;
an indicator for selectively identifying the actuating device for operating the operating mechanism; and
a housing for housing each of the operating mechanism and the indicator.
